(19) United States
(12) Patent Application Publication
(10) Pub. No.: US 2018/0253654 A1
(43) Pub. Date: Sep. 6, 2018

(54) GENERATING RULES BASED ON PATTERNS IN A COMMUNICATION TIME SERIES

(71) Applicant: salesforce.com, inc., San Francisco, CA (US)

(72) Inventors: Robert Michael Van Osten, San Jose, CA (US); Sean Lynch, Redwood City, CA (US); Matthew Burghoffer, Menlo Park, CA (US); Adam Evans, Redwood City, CA (US)

(21) Appl. No.: 15/449,371

(22) Filed: Mar. 3, 2017

(51) Int. Cl. G06N 5/02

(52) U.S. Cl. CPC G06N 5/025

(57) ABSTRACT

A system may generate rules based on identifying patterns within a set of communications. The system may determine moments and scores based on events and parameters within a communication of the set of communications. In some cases, the set of communications may be stored in a database, and the system may update the set of communications in real-time. The system may determine an insight based on the moments and scores across the set of communications. For example, the system may identify patterns of moments, scores, or the relationship between moments and scores. The system may determine the insight based on the identified pattern. The system may generate a rule based on the insight. In some cases, the rule may specify and action for the system to take. The system may implement the rule in real-time based on transmitting or receiving communications.

### FIELD OF TECHNOLOGY

The present disclosure relates generally to database systems and data processing, and more specifically to generating rules based on patterns in a communication time series.

### BACKGROUND

A cloud platform (i.e., a computing platform for cloud computing) may be employed by users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may process and store the communications associated with various CRM interactions in a database. Due to the volume and variety of communications associated with a particular interaction, it may be difficult to determine what occurred over the course of an interaction, what impact the communications had on the outcome of the interaction, and how to improve future interactions.

### BRIEF DESCRIPTION OF THE DRAWINGS

FIGS. 1 through 3 illustrate examples of environments for communication data processing that support generating rules based on patterns in a communication time series in accordance with aspects of the present disclosure.

FIG. 4 illustrates an example of a user interface (UI) that supports generating rules based on patterns in a communication time series in accordance with aspects of the present disclosure.

FIGS. 5 through 6 show block diagrams of a device that supports generating rules based on patterns in a communication time series in accordance with aspects of the present disclosure.

FIG. 7 illustrates a block diagram of a system including a time series insight manager that supports generating rules based on patterns in a communication time series in accordance with aspects of the present disclosure.

FIGS. 8 through 9 illustrate methods for identifying a statistically significant correlation between a pattern of moments and an outcome in accordance with aspects of the present disclosure.

FIGS. 10 through 12 illustrate methods for generating rules based on patterns in a communication time series in accordance with aspects of the present disclosure.

### DETAILED DESCRIPTION

A typical interaction between a customer and a business may involve dozens or even thousands of communications of various types (e.g., emails, phone calls, text messages, social media messages). Because of the volume and variety of communications, it may be difficult for the business to determine what occurred during the course of an interaction or how the communications impacted the final outcome of the interaction. Moreover, even if the business were able to discern a correlation between certain communications and the outcome of the interaction, it may be difficult to recognize this correlation in a subsequent interaction in sufficient time to take appropriate action. These difficulties may arise, for example, because of the massive amount of communications being exchanged, the variety of communication mediums being used, the number of different entities communicating, the real-time nature of the communications, or a combination of these factors.

A computing system (e.g., a cloud platform) supporting customer relationship management (CRM) may process and store communications associated with an interaction between a customer and a business, for example. The system may be configured to analyze the content of a communication (e.g., using natural language processing) to identify certain events or characteristics associated with the communication. The system may also be configured to analyze a series of communications for patterns of the identified events and characteristics or patterns of time durations between communications that may indicate causal relationships between certain events, characteristics, or time durations of a series of communications and certain outcomes associated with the series of communications. For example, the system may analyze a series of communications associated with a sales transaction, and may identify patterns within the communications that are associated with a positive outcome (e.g., closing a deal) or a negative outcome (e.g., losing a customer). The system may analyze and identify patterns in a series of communications in real time (e.g., as the communications are being exchanged).

The system may formulate a rule for responding to the identified patterns in subsequent communications to either achieve or avoid the outcome associated with the patterns. The system may display the rule or a suggestion associated with the rule to a user on a user interface (UI). The system may accept input from a user implement the rule as suggested or to modify the rule. The system may also formulate one or more actions to take in accordance with the rule. These actions may be displayed to and modified by a user. Upon identifying the patterns in a subsequent series of communications, the system may perform an action in accordance with the rule. In some examples, the system may automatically generate code that represents the rule or an action associated with the rule and may automatically implement the rule or the action.

Aspects of the disclosure are initially described in the context of computing environments for communication data processing. Aspects of the disclosure are then described in the context of an example UI. Aspects of the disclosure are further illustrated by and described with reference to apparatus diagrams, system diagrams, and flowcharts that relate to generating rules based on patterns in a communication time series.

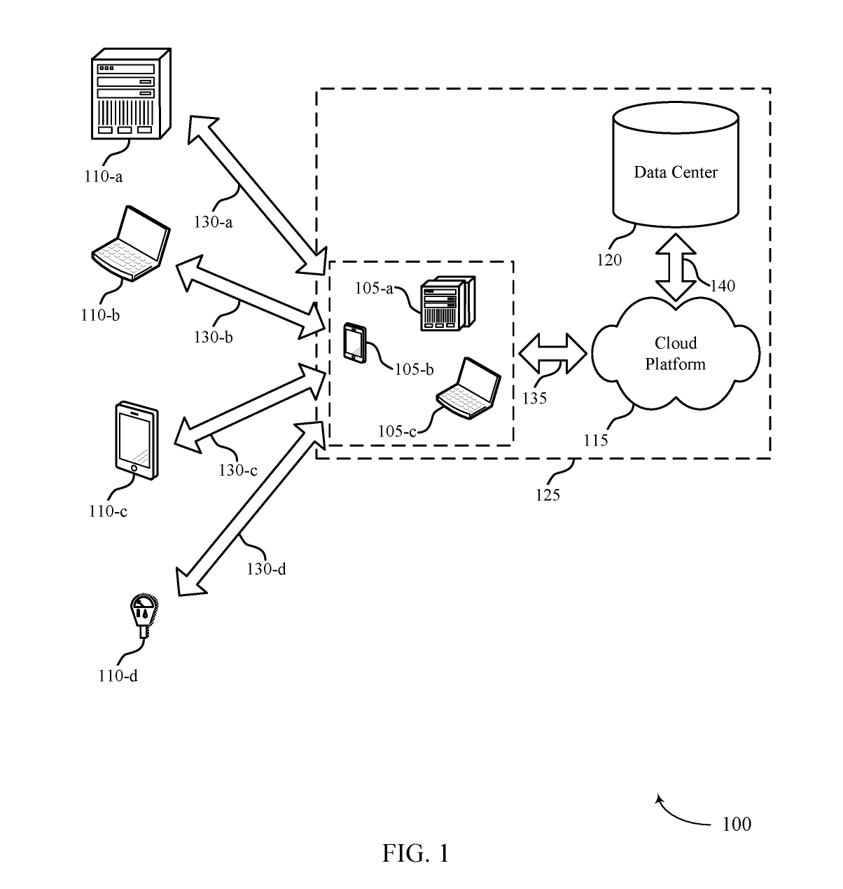

FIG. 1 illustrates an example of an environment 100 for cloud computing that supports generating rules based on patterns in a communication time series in accordance with various aspects of the present disclosure. The environment 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

System 125 may include cloud clients 105, cloud platform 115, and data center 120. In some cases, data processing may occur at any of the components of system 125, or at a combination of these components. In some cases, servers may perform the data processing. The servers may be a cloud client 105 or located at data center 120.

In accordance with aspects of the present disclosure, one or more components of system 125 may analyze the content of a communication (e.g., using natural language processing) to identify certain events or characteristics associated with the communication. System 125 may analyze a series of communications for patterns of events and characteristics that may indicate causal relationships between certain events or characteristics associated with the communications and certain outcomes associated with the communications. For example, system 125 may analyze a series of communications associated with a sales transaction, and may identify patterns within the communications that are associated with certain outcomes (e.g., closing a deal). System 125 may formulate a rule for responding to the identified patterns in subsequent communications to either achieve or avoid the outcome associated with the patterns. The system 125 may then identify the patterns in a subsequent series of communications and suggest or perform some action in accordance with the rule. The system 125 may therefore be configured to process vast amounts of communications in real time from a variety of communication mediums and entities to recognize patterns in the communications, formulate and suggest rules for responding to these patterns, and perform actions associated with the rules.

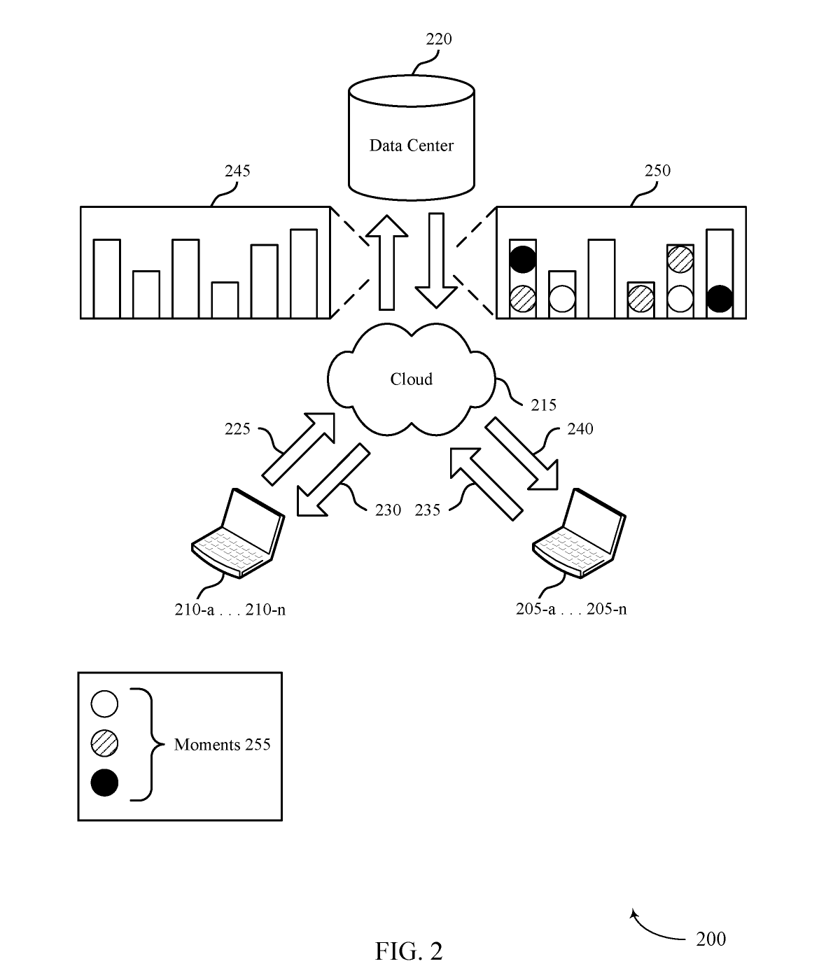

FIG. 2 illustrates an example of an environment 200 for communication data processing that supports generating rules based on patterns in a communication time series in accordance with various aspects of the present disclosure. The environment 200 includes cloud clients 205, contacts 210, cloud platform 215, and data center 220, which may be examples of the corresponding systems described with reference to FIG. 1. Environment 200 may include any number of cloud clients 205 and contacts 210 (e.g., cloud client 205-a to cloud client 205-n, and contact 210-a to contact 210-n).The cloud clients 205 or contacts 210 may be laptops, servers, smartphones, desktop computers, tablets, sensors, or other computing devices or systems capable of generating, analyzing, transmitting, or receiving communications.

Cloud client 205-a and contact 210-a may communicate over communication links 225, 230, 235, and 240, which may be examples of any wireless or wired data communication links. A communication may be an email, a calendar event, a service ticket, a short message service (SMS) text message, a voice call, a transcription of a voice call, a social media message, or any other form of electronic communication. Contact 210-a may transmit a first communication on communication link 225 to the cloud platform 215, and cloud client 205-a may receive the first communication on communication link 240. Additionally, cloud client 205-a may transmit a second communication on communication link 235, and contact 210-a may receive the second communication on communication link 230. In some examples, communications may be sent directly between contact 210-a and cloud client 205-a and then forwarded or otherwise shared with the cloud platform 215.

Cloud platform 215 may transmit communications to data center 220. The communications may be examples of communications transmitted or received by cloud client 205-a. As shown in graphical display 245, the communications may be represented as a bar graph, where the height of each bar indicates the number of communications over a given time period (e.g., hours, days, or weeks). Communications over a given period of time may be referred to as a time series of communications.

Data center 220 may perform analysis on a time series of communications (e.g., using natural language processing) to identify certain properties of a communication. For example, a communication may be analyzed to determine whether a specific event occurred during a communication or was otherwise associated with the communication. A communication may also be analyzed to determine a numerical assessment associated with a characteristic of the communication. These properties or a combination of these properties may be generally referred to as communication moments associated with a communication. In some examples, whether a particular event occurred may be referred to as a moment, whereas a numerical assessment of a communication may be referred to as a score. As shown in graphical display 250, the moments 255 may be illustrated as circles superimposed over the bar representing the communications that the moments 255 are associated with.

Moments may be designated by different types, as illustrated by the different fill patterns of the moments 255 in the graphical display 250. The different types of moments may include a competitor mention, a product mention, pricing mention, timing mention, specific member involvement, a specific attachment to the communication, scheduling of a meeting, rescheduling of a meeting, or any other occurrence associated with a communication. In some cases, a moment may be represented as a Boolean value. For example, data center 220 may set a moment to one value if it identifies that the specific event occurs, and may set the moment to a different value if it does not identify that the specific event occurs. Alternatively, data center 220 may not create a moment if it does not identify that the specific event occurred during a communication.

In some cases, data center 220 may perform analysis on the time series of communications (e.g., using natural language processing) to identify a numerical characterization of a communication. These numerical characterizations of communications may be referred to as scores associated with a communication. The score may also be referred to as a parametric score. In some examples, the score may be a value between 0 and 1. A communication may be analyzed and numerically assessed based on agreeability, tone, responsiveness, or any other measureable characterization of a communication. The information gleaned from the combination of moments and scores over the course of a time series of communications may be referred to as an insight.

In some examples, data center 220 may identify moments, scores, and insights dynamically (e.g., in real time) as communications are transmitted or received. In other examples, data center 220 may identify moments, scores, and insights from batches of data, which may be stored in a database at data center 220. In some examples, cloud client 205 or a server associated with cloud platform 215 may identify the moments, scores, and insights from a time series of communications based on communications transmitted and received by cloud client 205-a. In these examples, data center 220 may or may not receive or process the communications.

The data center 220 may analyze the moments over a series of communications for patterns. The system within data center 220 performing pattern analysis may be the same or a different system than the system that identified the moments from the communications in the first place. The patterns in the series of communications may be related to a temporal relationship between moments of certain types, a temporal relationship between specific communications of the series of communications, a ratio of occurrence between moments of certain types, a relationship between moments and scores over time, a change in the occurrence of moments, scores, or communications of the series of communications over time, or any other pattern based on the moments, scores and/or communications of the series of communications. The data center 220 may identify a correlation between these patterns and an outcome associated with the communications (e.g., closing a deal, losing a customer, etc.). In some cases, the data center 220 may identify patterns of a designated statistical significance (e.g., comparing positive outcomes and negative outcomes associated with the communications using a Chi-squared test with a 99 percent confidence interval). The data processing required to identify the moments, scores, or patterns may occur at the data center 220, at the cloud platform 215, or at the cloud client 205-a (e.g., in a web browser), at a combination of these locations, or at another device or system. In some cases, the data center 220 may receive a new communication during or after the analysis, and the data center 220 may update the series of communications with the new communication. The data center 220 may analyze the updated series of communications, and perform an updated analysis to identify patterns, as discussed above.

In one example of moment pattern recognition, the time duration between moments of different types is analyzed. For example, the data center 220 may organize all the moments that occurred over the course of a particular time series of communications in a matrix (e.g., with size N×N). The data center 220 may then calculate the time duration between each pair of moments of different types (e.g., the time duration between when a competitor product is mentioned and when pricing is mentioned). This analysis may be performed for multiple time series of communications to determine the average time between any two moment types. The data center 220 may also determine the average time between any two moment types for a time series of communications associated with a particular outcome (e.g., closing a deal, losing a deal, etc.). The data center 220 may then compare the average times for communications that led to a positive outcome against the average times for communications that led to a negative outcome. The data center 220 may then determine whether there is a statistically significant correlation between the average times for communications and the positive outcome by comparing it to the average time times for communications that led to the negative outcome.

In another example, the data center 220 may determine whether a particular sequence of moments or moment types is correlated with a particular outcome. For example, the data center 220 may determine whether discussing a product before scheduling a meeting is correlated with a positive outcome (e.g., closing a deal). The data center 220 may determine a correlation between a sequence of moments and an outcome by first creating a list of the potential permutations of moment-type sequences up to a predetermined size. The data center 220 may then analyze a time series of communications to find a match of a particular moment-type sequence permutation occurring within that series of communications. In some examples, the data center 220 may use a pattern matching algorithm (e.g., Knuth-Morris-Pratt) to find a match. The data center 220 may then count the total number of matches for a given permutation over the course of one or more series of communications (e.g., by incrementing a counter). The data center 220 may then determine whether there is a statistically significant correlation between a particular moment-type sequence permutation and a particular outcome.

The data center 220 may perform additional types of analyses to identify patterns of moments over the course of one or more series of communications. For example, the data center 220 may determine how often a moment of a first type occurs before a moment of a second type. Additionally, or alternatively, the data center 220 may determine a ratio between two different moment types over the course of a series of communications. The data center 220 may then determine if these patterns are correlated with particular outcomes, as discussed above.

The data center 220 may convey an identified pattern to a user. For example, the data center 220 may determine that an average time duration between a competitor product mention moment and a pricing mention moment is 5 days. The cloud client 205-a may receive a notification of this pattern from the data center 220 (e.g., after five days), and may display the pattern to a user in a UI.

The data center 220 may determine a rule based on one or more identified patterns of moments. The rule may specify or suggest an action to implement when a particular pattern is identified in a subsequent series of communications. The data center 220 may automatically generate code, that when processed, may implement the rule. The data center 220 may implement the rule dynamically as communications are transmitted and received. For example, the data center 220 may identify the certain frequency, pattern, or change in moments or scores in a second series of communications. The data center 220 may process the code to perform the action based on the identification. In some cases, the action may include sending a push notification, assigning a user a task, drafting or sending an email, or another action involving an automated computing process. In some cases, the data center 220 may receive a new communication and may update the series of communications. The data center 220 may also automatically update a rule based on updating the series of communications.

The data center 220 may also determine and convey a suggestion via a UI to a user based on the identified pattern and an associated rule. The suggestion may indicate a forecasted relationship between an outcome event and the rule. For example, the suggestion may be that reducing the time duration from 5 days to 4 days may increase the success score (e.g., the likelihood of closing a deal) by 0.1 (i.e., 10%). In this example, the suggestion relates the outcome event of an increased success score to the rule of implementing a pricing moment mention within 4 days of a competitor product mention. Cloud client 205-a may also receive and display the suggestion in the UI.

The data center 220 may transmit the code or an indication of the rule to cloud client 205-a. Cloud client 205-a may display the code or the indication of the rule in the UI. In some cases, a user may modify the rule, or may determine a new rule. In some examples, upon creation, the code may be automatically implemented in the system. In other examples, the user may provide input to cloud client 205-a to approve implementing the code. The data center 220 may also transmit an indication of the action to cloud client 205-a. Cloud client 205-a may display the indication of the action in the UI. In some cases, the user may select a different action than the specified action, modify an action, or create a new action.

In one exemplary user case, a time duration between moments of different types is analyzed. In this case, a system, such as the data center 220, the cloud platform 215, or cloud client 205-a, may identify different types of moments and scores in a series of communications. For example, the data center 220 may create an array or matrix of the identified moments, and may calculate the time duration between different types of moments. The data center 220 may determine a success score for the communications. For example, the data center 220 may rate the success of the communication from 0 to 1, based on natural language processing, data analysis, or input from a user. The data center 220 may determine whether there is a statistical significance between the success score and the time duration. For example, the data center 220 may determine that there is a statistical significance between the success score and a time duration between a competitor product mention moment and a pricing mention moment.

The data center 220 may convert the identified pattern into information that is useable and understandable to a user (e.g., referred to as an insight). For example, the insight may be that an average time duration between a competitor product mention moment and a pricing mention moment is 5 days. The data center 220 may transmit this insight to cloud client 205-a to display in a UI. The data center 220 may also determine a suggestion, based on the determination of a statistical significance. For example, the suggestion may be that reducing the time duration from 5 days to 4 days may increase the success score by 0.1. The data center 220 may also transmit the suggestion to cloud client 205-a to display in the UI. In some cases, the user may provide an input to adjust the suggestion. For example, the user may input a value of 3 days for the time duration between a competitor product mention moment and a pricing mention moment. The suggestion may be adjusted to be, for example, that reducing the time duration from 5 days to 3 days may increase the success score by 0.15.

The data center 220 may additionally determine an action. For example, the data center 220 may determine that a push notification may be sent. For example, if 3 days have passed and the data center 220 has not identified a pricing mention in a communication, the data center 220 may send the push notification message to inform the sales representative to include a pricing mention in a communication. The data center 220 may transmit an indication of the action to cloud client 205-a to be displayed in the UI. In some cases, the user may be able to select a different action than the determined action. For example, the user may select to automatically send an email including a pricing mention in the communication within 3 days.

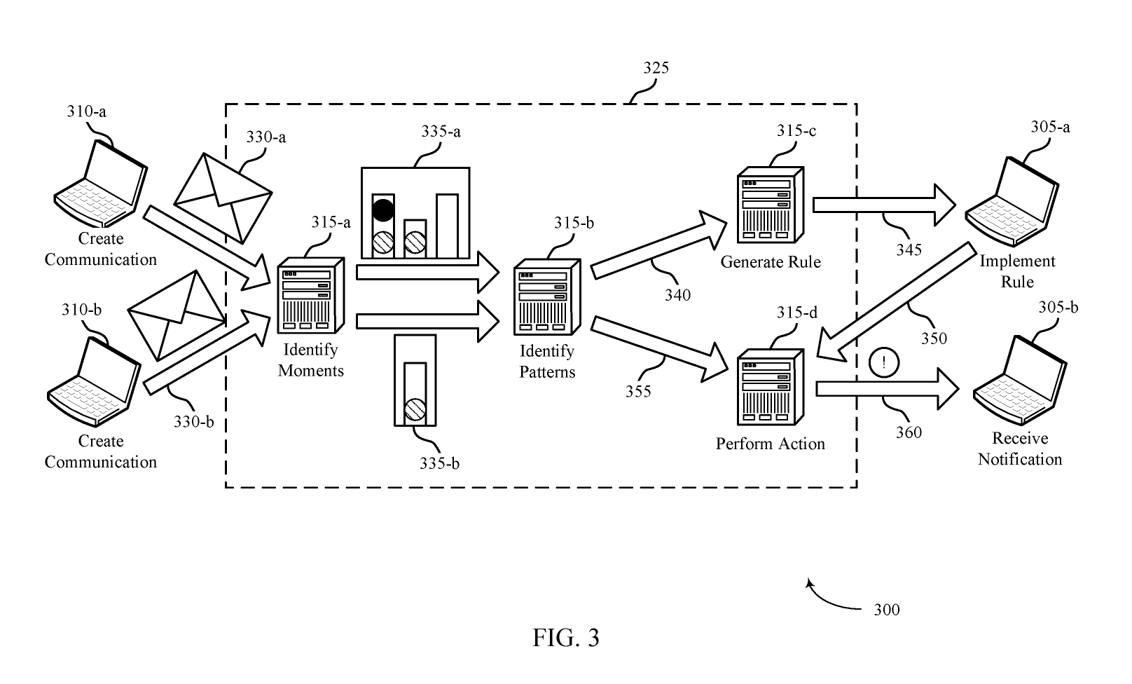

FIG. 3 illustrates an example of an environment 300 for communication data processing that supports generating rules based on patterns in a communication time series in accordance with various aspects of the present disclosure. Environment 300 may include multiple cloud clients 305, multiple contacts 310, and one or more servers 315 within a system 325. In some cases, servers 315-a, 315-b, 315-c, and 315-d may be examples of separate servers physically located at different positions. In other cases, some or all of the processes performed by servers 315-a, 315-b, 315-c, and 315-d may be performed by a single server. In yet other cases, the processes performed by servers 315-a, 315-b, 315-c, and 315-d may instead be performed by a user device (e.g., a smartphone, a laptop, a desktop computer, a tablet, a sensor, or another computing device or system capable of processing or analyzing communications). The cloud clients 305 and contacts 310 may be examples of the corresponding systems described with reference to FIGS. 1 and 2. The system 325 may be an example of the system 125 as described with reference to FIG. 1. In some cases, servers 315-a, 315-b, 315-c, and 315-d may be examples or components of a cloud client, a cloud platform, or a data center as described with reference to FIGS. 1 and 2.

Contact 310-a may create a communication (e.g., email 330-a). Contact 310-a may send email 330-a to system 325. Server 315-a may receive and process email 330-a. Email 330-a may be one communication event within a time series of communications. Server 315-a may analyze the time series of communications to identify moments, scores, and outcomes. For example, server 315-a may perform natural language processing on email 330-a to identify moments, scores, or outcomes within the email. In one example, server 315-a may identify a competitor mention moment within email 330-a.

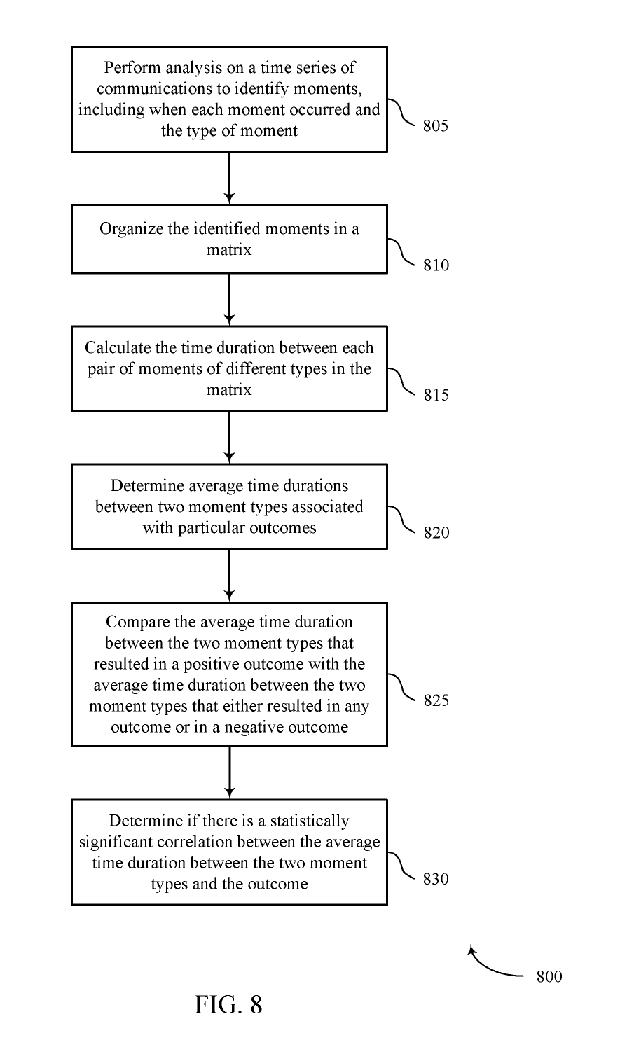

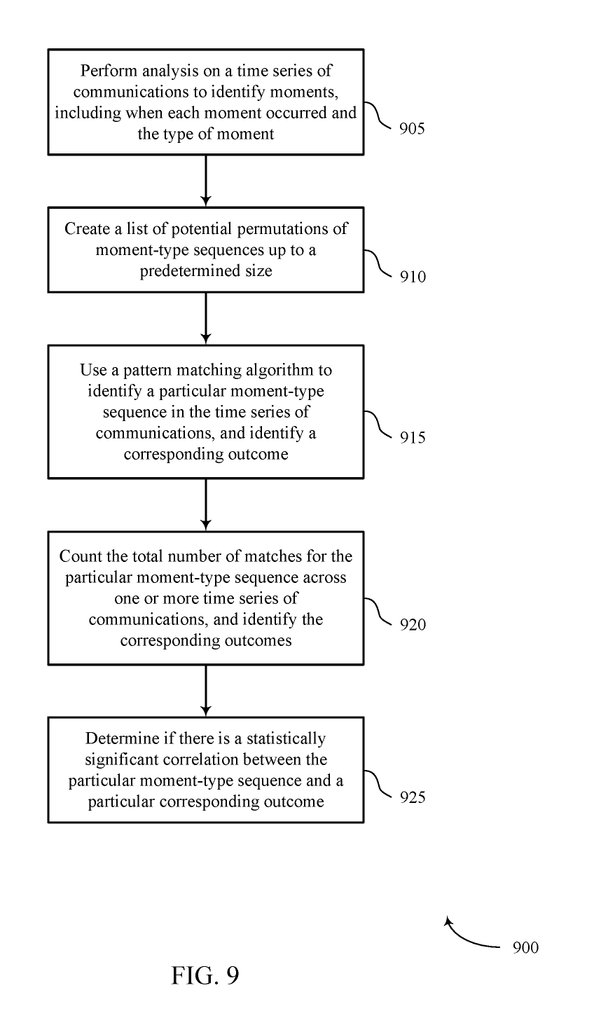

Server 315-a may send the time series of communications, including the identified moments, scores, and outcomes to server 315-b. In some cases, the time series of communications, including the identified moments an scores, may be represented by graphical representation 335-a. Server 315-b may receive the time series of communications and analyze the moments, scores, and outcomes for patterns. Server 315-b may perform this process using a method, such as method 800 or 900 as described with reference to FIGS. 8 and 9. Sever 315-b may additionally or alternatively perform functionality of the data center 220 as described with reference to FIG. 2.

Server 315-b may send the identified patterns and associated time series of communications to server 315-c over data link 340. Server 315-c may generate a rule based on the identified patterns. Generating the rule may involve generating computer code that may be processed by a computing device (e.g., a server, a laptop, etc.). The rule may specify an action to take if a similar pattern or portion of a pattern is identified in another time series of communications.

Server 315-c may send the rule or an indication of the rule to cloud client 305-a over communication link 345. The communication link 345 may be an example of any wireless or wired data communication link. Cloud client 305-a may display the rule or the indication of the rule in a UI. In some cases, system 325 may automatically implement the rule upon generation. In other cases, a user may provide an input to the UI to implement the rule. For example, the user may click a button to select the rule for implementation. The user input may be transmitted to the system 325 on communication link 350. Server 315-d may receive the rule and the user input, and may implement the rule based on the user input.

Contact 310-b may also communicate with a cloud client 305 via system 325. For example, contact 310-b may create an email 330-b, and may send the email 330-b to system 325. Server 315-a may receive email 330-b and may process the email. Server 315-a may perform natural language processing on email 330-b to identify moments, scores, and outcomes. In one case, server 315-a may identify a competitor mention moment in email 330-b. Server 315-a may also identify email 330-b as associated with a specific time series of communications. Server 315-a may send the communications, including the identified moments, scores, and outcomes to server 315-b. In some cases, the communication and the identified moments, scores, and outcomes may be represented by graphical representation 335-b.

Server 315-b may receive the communication with the identified moments, scores, and outcomes, and may identify a pattern or portion of the pattern within the communication or the associated specific time series of communications. For example, server 315-b may identify the recent competitor mention moment. The server 315-b may recognize the competitor mention moment as the beginning of the pattern associated with an implemented rule. Server 315-b may send an indicator of the identified portion of the pattern to server 315-d over data link 355.

Server 315-d may implement the rule based on the user input received over communication link 350. Server 315-d may receive the indicator of the identified portion of the pattern (e.g., the competitor mention moment in email 330-b) and may perform a specified action based on implementing the rule. For example, processing the code to implement the rule may result in the transmission of a notification message 360 to a user, where the notification message 360 includes instructions for the user to respond to email 330-b within three days. Responding within three days to an email 330 with a competitor mention moment may have a statistically significant correlation to retaining a contact 310 as a customer.

Server 315-d may transmit the notification message 360 to cloud client 305-b. In some cases, cloud client 305-b and cloud client 305-a may be the same entity. In other cases, cloud client 305-b and cloud client 305-a may be separate entities located at distinct locations. Cloud client 305-b may display the notification message 360 in a UI to a user. The user may read the notification message 360, and in some cases may use the information contained in the notification message 360 to respond to email 330-b. For example, the user may send an email from cloud client 305-b to contact 310-b within three days of email 330-b. Sending the email in response to the identified competitor mention moment within three days, as opposed to after three days, may increase the probability of retaining contact 310-b as a customer.

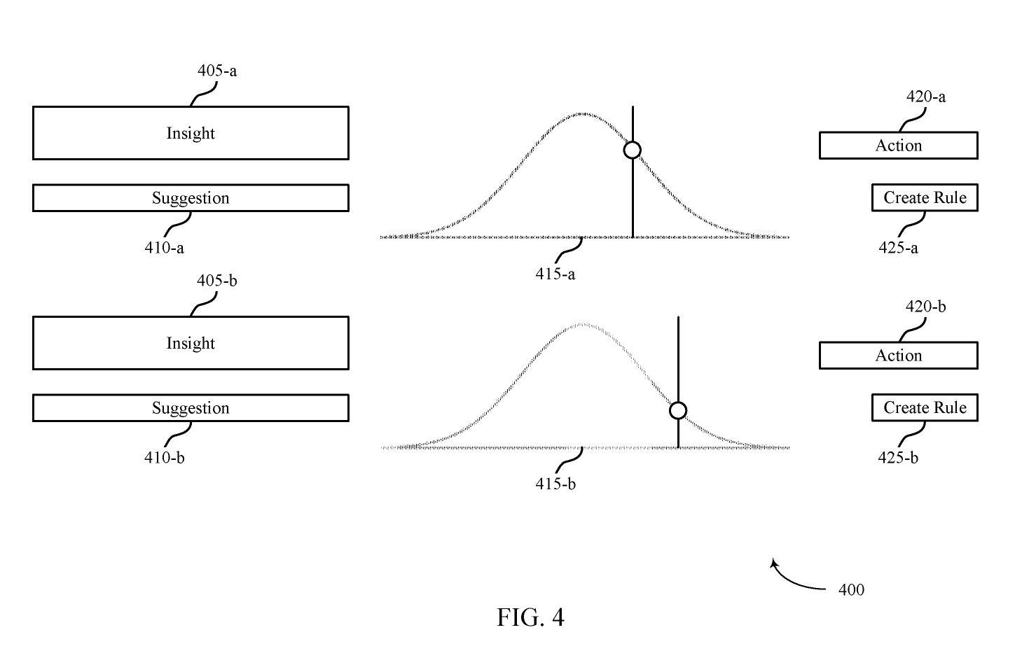

FIG. 4 illustrates an example of a UI 400 that supports generating rules based on patterns in a communication time series in accordance with various aspects of the present disclosure. UI 400 may include insight fields 405-a and 405-b, suggestion fields 410-a and 410-b, interactive plots 415-a and 415-b, action fields 420-a and 420-b, and rule creation buttons 425-a and 425-b. In some cases, UI 400 may display fields, plots, or buttons in addition to the ones described. In other cases, UI 400 may not display some of the fields, plots, or buttons described. In some examples, the UI may be displayed to a user by a cloud client 205 as described with reference to FIG. 2.

The UI 400 may display patterns and insights to the user. The UI 400 may be configured to receive an input from the user. The input may identify specific moments or scores to be analyzed for insights. In some cases, the UI 400 may display a list of the specific moments or scores. Cloud client 205-a or another system may process the specific moments or scores to identify any patterns of statistical significance. The UI 400 may display the patterns or an indication of the patterns to the user. The UI 400 may also present an insight to the user as a scenario. For example, the UI 400 may display the insight in writing in insight field 405-a. The user may select insights for the system to display.

The UI 400 may also display rules and actions. The UI 400 may display the rule as generated code or as an indication of the rule. In some cases, cloud client 205-a may automatically implement the rule. In other cases, the user may select whether to implement the rule. The user may input the selection into the UI 400 (e.g., by clicking on rule creation button 425-a). In some cases, the user may modify the rule. For example, the user may input an alteration to the generated code. In other cases, the user may input information to create a new rule. The UI 400 may display an indication of an action in action field 420-a. In some cases, the user may select a different action than the indicated action. In other cases, the user may input information to create a new action.

The UI 400 may also display a suggestion to the user in suggestion field 410-a. The suggestion may indicate a forecasted relationship between an outcome event and the rule. The UI 400 may also display interactive plot 415-a. Interactive plot 415a may be based on the suggestion, the insight, or the rule. In some cases, the user may adjust the suggestion by interacting with interactive plot 415-a. For example, interactive plot 415a may be a curve of values. The user may select a position on the curve of values, which may represent a specific suggestion. The user may then create a rule based on the specific suggestion.

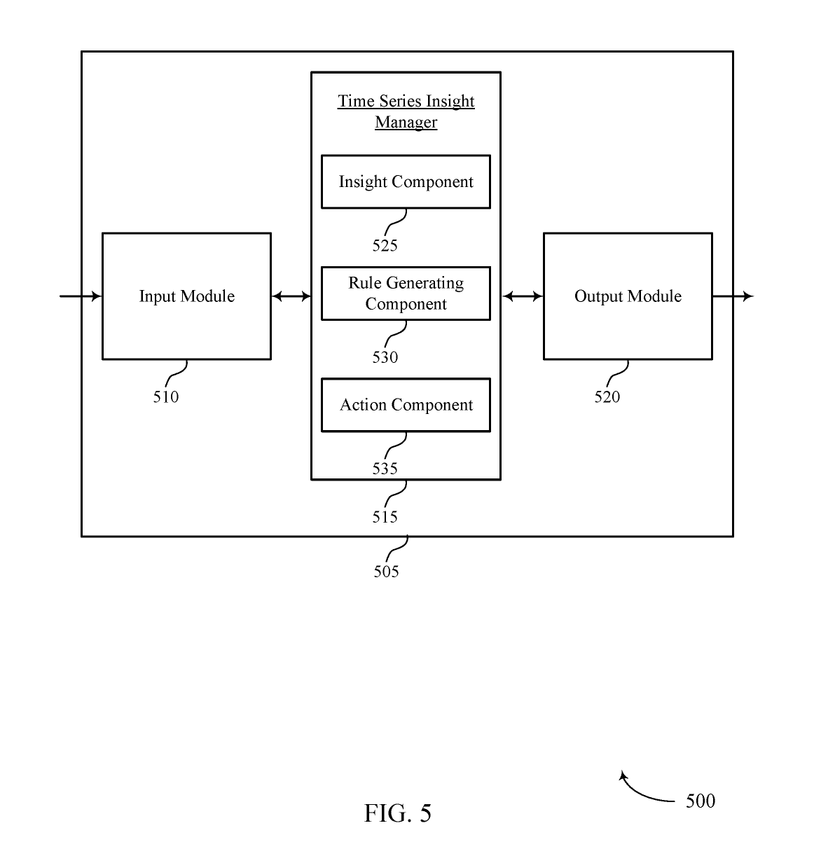

FIG. 5 shows a block diagram 500 of a system 505 that supports generating rules based on patterns in a communication time series in accordance with various aspects of the present disclosure. System 505 may be an example of any of the systems or computing devices described with reference to FIGS. 1-4. System 505 may include input module 510, time series insight manager 515, and output module 520. System 505 may also include a processor. Each of these components may be in communication with one another (e.g., via one or more buses). In some cases, system 505 may be an example of a user terminal, a database server, or a system containing multiple computing devices.

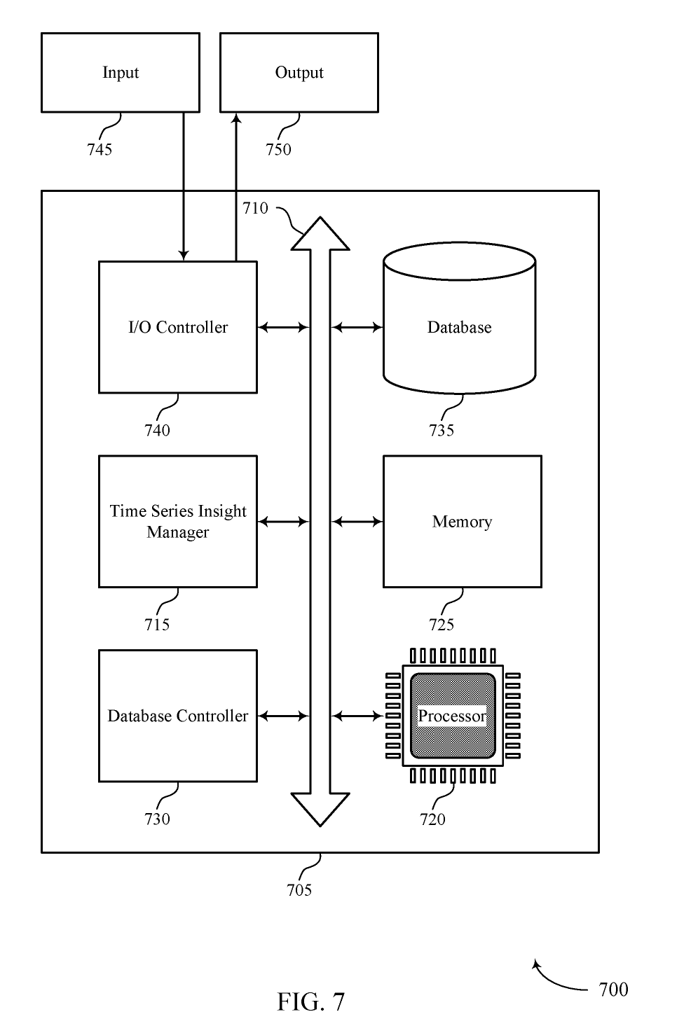

Time series insight manager 515 may be an example of aspects of the time series insight manager 715 described with reference to FIG. 7. Time series insight manager 515 may also include insight component 525, rule generating component 530, and action component 535. Time series insight manager 515 and/or at least some of its various sub-components may be implemented in hardware, software executed by a processor, firmware, or any combination thereof. If implemented in software executed by a processor, the functions of the time series insight manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The time series insight manager 515 and/or at least some of its various sub-components may be physically located at various positions, including being distributed such that portions of functions are implemented at different physical locations by one or more physical devices. In some examples, time series insight manager 515 and/or at least some of its various sub-components may be a separate and distinct component in accordance with various aspects of the present disclosure. In other examples, time series insight manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Insight component 525 may identify a relationship between an outcome event and a pattern in a first time series of communication moments, where each communication moment of the first time series includes a property of a communication event derived based on an analysis of the communication event. The insight component 525 may also identify the pattern in a second time series of communication moments. The insight component 525 may identify the pattern in the first time series, where identifying the pattern in the first time series includes identifying a time duration between communication moments of different types, identifying a sequence of occurrences between communication moments of different types, identifying a ratio between communication moments of different types, or identifying a combination thereof. In some cases, the property of the communication event includes an occurrence associated with the communication event, a score associated with the communication event, or a combination thereof. In some cases, the communication event includes an email, a calendar event, a service ticket, a SMS text message, a voice call, a social media message, or a combination thereof.

Rule generating component 530 may generate code representing a rule corresponding to the pattern, where the code is generated automatically, and where the rule identifies an action for responding to the pattern and update the code based on the updated first time series.

Action component 535 may process the code to perform the action based on identifying the pattern in the second time series.

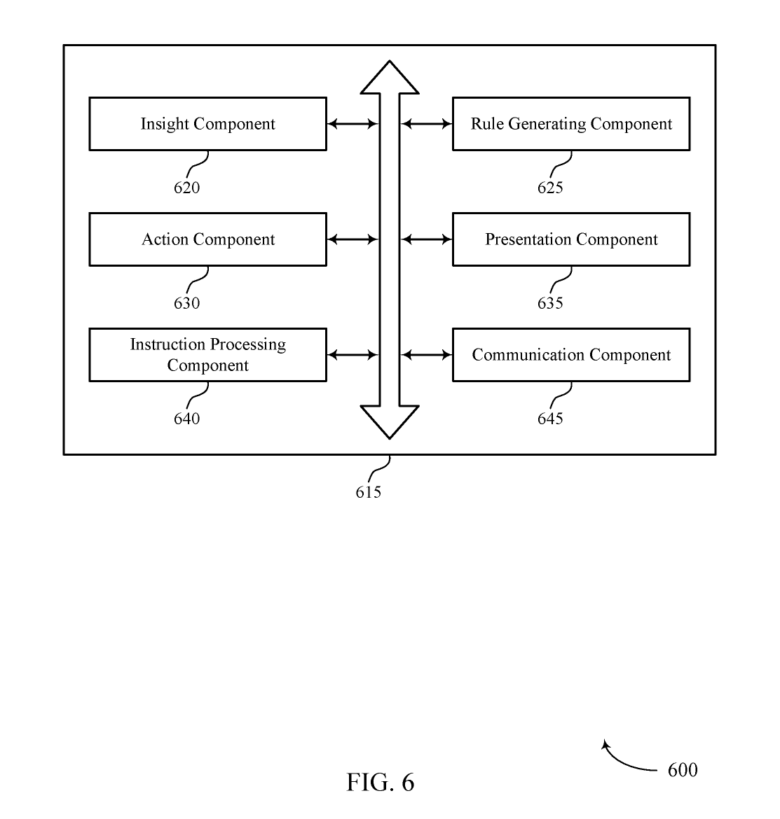

FIG. 6 shows a block diagram 600 of a time series insight manager 615 that supports generating rules based on patterns in a communication time series in accordance with various aspects of the present disclosure. The time series insight manager 615 may be an example of aspects of a time series insight manager 715 described with reference to FIGS. 5 and 7. The time series insight manager 615 may include insight component 620, rule generating component 625, action component 630, presentation component 635, instruction processing component 640, and communication component 645. Each of these modules may communicate, directly or indirectly, with one another (e.g., via one or more buses).

Insight component 620 may identify a relationship between an outcome event and a pattern in a first time series of communication moments, where each communication moment of the first time series includes a property of a communication event derived based on an analysis of the communication event, and identify the pattern in a second time series of communication moments. The insight component 620 may identify the pattern in the first time series, where identifying the pattern in the first time series includes identifying a time duration between communication moments of different types, identifying a sequence of occurrences between communication moments of different types, identifying a ratio between communication moments of different types, or identifying a combination thereof. Communication component 645 may receive at least a new communication event and update the first time series based on the new communication event.

Rule generating component 625 may generate code representing a rule corresponding to the pattern, where the code is generated automatically, and where the rule identifies an action for responding to the pattern and update the code based on the updated first time series. Action component 630 may process the code to perform the action based on identifying the pattern in the second time series.

Presentation component 635 may display an indication of the rule to a user, display an indication of the pattern to a user, and display a forecasted relationship between the outcome event and the rule. Instruction processing component 640 may receive an input from the user to implement the rule, receive an input from a user to modify the rule, where the input includes an alteration to the code, and receive an input from a user to select the types of communication moments to use for identifying the pattern.

FIG. 7 shows a diagram of an environment 700 including a system 705 that supports generating rules based on patterns in a communication time series in accordance with various aspects of the present disclosure. In some cases, system 705 may be an example of a user terminal, a database server, or a system containing multiple computing devices. System 705 may be an example of or include the components of system 125, or any other system or component as described above, e.g., with reference to FIGS. 1-6. System 705 may include components for data storage and processing, as well as user interaction, including time series insight manager 715, processor 720, memory 725, database controller 730, database 735, and I/O controller 740. These components may be in electronic communication via one or more busses (e.g., bus 710).

Processor 720 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting generating rules based on patterns in a communication time series).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware and/or software operation such as the interaction with peripheral components or devices.

Database controller 730 may manage data storage and processing in database 735. In some cases, a user may interact with database controller 730. In other cases, database controller 730 may operate automatically without user interaction. Database 735 may be an example of a single database, a distributed database, multiple distributed databases, or an emergency backup database.

I/O controller 740 may manage input and output signals for device 705. I/O controller 740 may also manage peripherals not integrated into device 705. In some cases, I/O controller 740 may represent a physical connection or port to an external peripheral. In some cases, I/O controller 740 may utilize an operating system such as iOS®, ANDROID®, MS-DOS®, MS-WINDOWS®, OS/2®, UNIX®, LINUX®, or another known operating system. In other cases, I/O controller 740 may represent or interact with a modem, a keyboard, a mouse, a touchscreen, or a similar device. In some cases, I/O controller 740 may be implemented as part of a processor. In some cases, a user may interact with device 705 via I/O controller 740 or via hardware components controlled by I/O controller 740.

FIG. 8 shows a flowchart illustrating a method 800 for identifying a statistically significant correlation between a pattern of moments and an outcome in accordance with various aspects of the present disclosure. The operations of method 800 may be implemented by a system 125, or any other system or component as described herein. For example, the operations of method 800 may be performed by a time series insight manager as described with reference to FIGS. 5 through 7. In some examples, a system 125 may execute a set of codes to control the functional elements of the system to perform the functions described below. Additionally or alternatively, the system 125 may perform aspects of the functions described below using special-purpose hardware.

At block 805 the system 125 may perform analysis on one or more time series of communications to identify moments. The analysis may include identifying when each moment occurred (e.g., a timestamp of the communication event the moment was identified in) and the type of moment (e.g., pricing mention, product mention, etc.).

At block 810 the system 125 may organize the identified moments in a matrix. The matrix may identify pairs of moments, where the pairs of moments consist of two identified moments.

At block 815 the system 125 may calculate the time duration between each identified pair of moments of different moment types. In some cases, the system 125 may calculate the time duration based on a timestamp associated with each moment of the pair of moments. For example, the system 125 may calculate the time duration between a product mention moment and a pricing mention moment.

At block 820 the system 125 may determine average time durations between two moment types associated with particular outcomes. For example, the system 125 may determine the average time duration between a product mention moment and a pricing mention moment associated with a positive outcome (e.g., selling the product). The system 125 may additionally calculate the average time duration between a product mention moment and a pricing mention moment associated either with a negative outcome (e.g., not selling the product) or any outcome (e.g., both selling and not selling the product).

At block 825 the system 125 may compare the determined average time durations. For example, the system 125 may compare the average time duration between a product mention moment and a pricing mention moment associated with a positive outcome with the average time duration between a product mention moment and a pricing mention moment associated with any outcome. In some cases, the system 125 may calculate a difference between the average time durations. The system 125 may also calculate a standard deviation for the difference.

At block 830 the system 125 may determine if there is a statistically significant correlation between the average time duration between the moment types and the outcome. In some cases, the determination may be based on using a Chi-squared test with a 99 percent confidence interval or any other known statistical test. For example, the system 125 may determine that there is a statistically significant correlation between the average time duration between product mention moments and pricing mention moments and selling the product. The determination may be based on a much smaller average time duration between product mention moments and pricing mention moments that result in selling the product than the average time duration between product mention moments and pricing mention moments that result in any outcome.

FIG. 9 shows a flowchart illustrating a method 900 for identifying a statistically significant correlation between a pattern of moments and an outcome in accordance with various aspects of the present disclosure. The operations of method 900 may be implemented by a system 125, or any other system or component as described herein. For example, the operations of method 900 may be performed by a time series insight manager as described with reference to FIGS. 5 through 7. In some examples, a system 125 may execute a set of codes to control the functional elements of the system to perform the functions described below. Additionally or alternatively, the system 125 may perform aspects of the functions described below using special-purpose hardware.

At block 905 the system 125 may perform analysis on one or more time series of communications to identify moments. The analysis may include identifying when each moment occurred (e.g., a timestamp of the communication event the moment was identified in) and the type of moment (e.g., pricing mention, product mention, etc.).

At block 910 the system 125 may create a list of potential permutations of moment-type sequences up to a predetermined size. For example, one potential permutation of a moment-type sequence with a size of 3 may be a product mention, followed by a competitor mention, followed by a pricing mention. In some cases, the moment-type sequences may include repeat moment-types.

At block 915 the system 125 may use a pattern matching algorithm (e.g., Knuth-Morris-Pratt) to identify a particular instance of a moment-type sequence in the one or more time series of communications. The system 125 may also identify an outcome corresponding to the particular instance of the moment-type sequence. For example, the above potential permutation (i.e., product mention-competitor mention-pricing mention) may be identified in a particular instance in the one or more time series of communications. Additionally, the system 125 may identify an outcome (e.g., selling the product) associated with the particular instance.

At block 920 the system 125 may count the total number of instances of a permutation of a moment-type sequence in the one or more time series of communications. For example, the system 125 may identify multiple instances of the above potential permutation across the one or more time series of communications, and may identify the outcomes of the multiple instances.

At block 925 the system 125 may determine if there is a statistically significant correlation between a particular permutation of a moment-type sequence and an outcome. In some cases, the system 125 may compare the number of instances of the particular permutation of the moment-type sequence resulting in a particular outcome to the total number of instances of the particular permutation of the moment-type sequence. For example, the system 125 may determine that there is a statistically significant correlation between the above potential permutation (i.e., product mention-competitor mention-pricing mention) and selling the product.

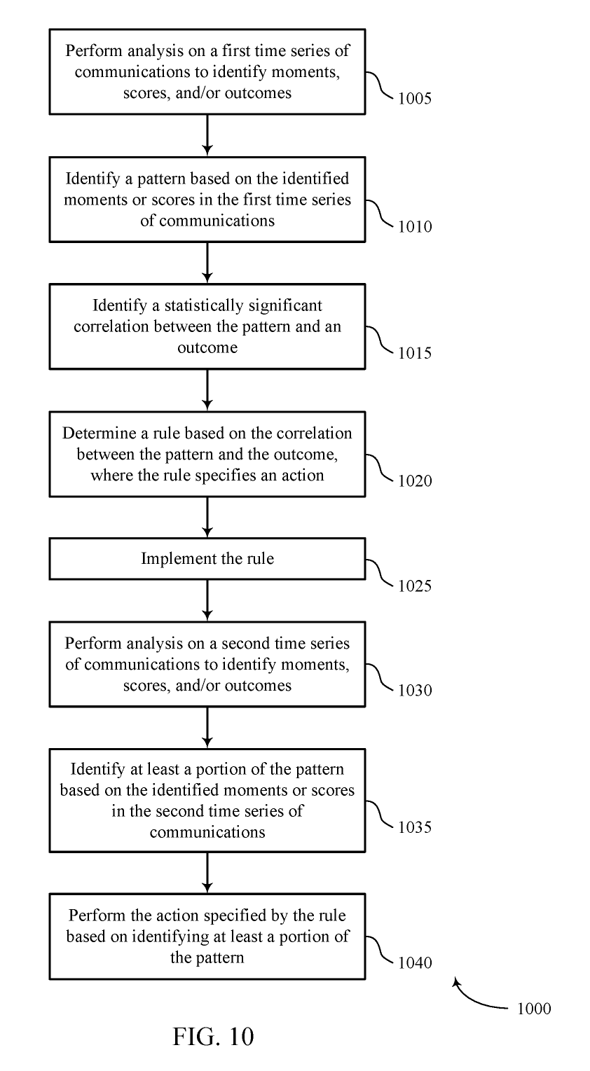

FIG. 10 shows a flowchart illustrating a method 1000 for generating rules based on patterns in a communication time series in accordance with various aspects of the present disclosure. The operations of method 1000 may be implemented by a system 125 or its components as described herein. For example, the operations of method 1000 may be performed by a time series insight manager as described with reference to FIGS. 5 through 7. In some examples, a system 125 may execute a set of codes to control the functional elements of the system to perform the functions described below. Additionally or alternatively, the system 125 may perform aspects of the functions described below using special-purpose hardware.

At block 1005 the system 125 may perform analysis on one or more time series of communications to identify moments, scores, and outcomes. The analysis may include identifying when each moment or score occurred (e.g., a timestamp of the communication event the moment was identified in or the score was associated with). The analysis may also include identifying the type of moment (e.g., pricing mention, product mention, etc.), score (e.g., agreeability, responsiveness, etc.), or outcome (e.g., selling a product, adding a contact, etc.).

At block 1010 the system 125 may identify a pattern based on the identified moments or scores in the first time series of communications. At block 1015 the system 125 may identify a statistically significant correlation between the pattern and an outcome. In some cases, the functionality presented in blocks 1005, 1010, and 1015 may be performed according to methods 800 and 900 as described with reference to FIGS. 8 and 9.

At block 1020 the system 125 may determine a rule based on the statistically significant correlation between the pattern and the outcome. The rule may specify an action. For example, the system 125 may determine a statistically significant correlation between adding a manager to a communication within 2 days of a competitor mention and a positive outcome (e.g., completing a sale). Therefore, the action may include sending a notification to a user. The notification may request the user to add a manager to the communication. Determining the rule may include the system 125 generating code to implement the rule.

At block 1025 the system 125 may implement the rule. In some cases, the system 125 may automatically implement the rule following determination of the rule. In other cases, a user may select whether to implement the rule.

At block 1030 the system 125 may perform analysis on a time series of communications to identify moments, scores, and outcomes. In some cases, the time series of communications may be one of the one or more time series of communications that the system 125 previously analyzed. In other cases, the time series of communications may be a time series of communications that has not yet been analyzed. In some cases, the time series of communications may include recently transmitted or received communications that may not have been analyzed by the system 125.

At block 1035 the system 125 may identify at least a portion of the pattern associated with the rule based on the identified moments, scores, or outcomes. For example, the system 125 may identify a competitor mention moment in a communication received within the past day.

At block 1040 the system 125 may perform the action specified by the rule based on identifying at least a portion of the pattern. For example, the system 125 may send a notification (e.g., a push notification) to a user based on identifying a competitor mention moment. The notification may instruct the user to add a manager to the communication within 2 days of the competitor mention moment occurring.

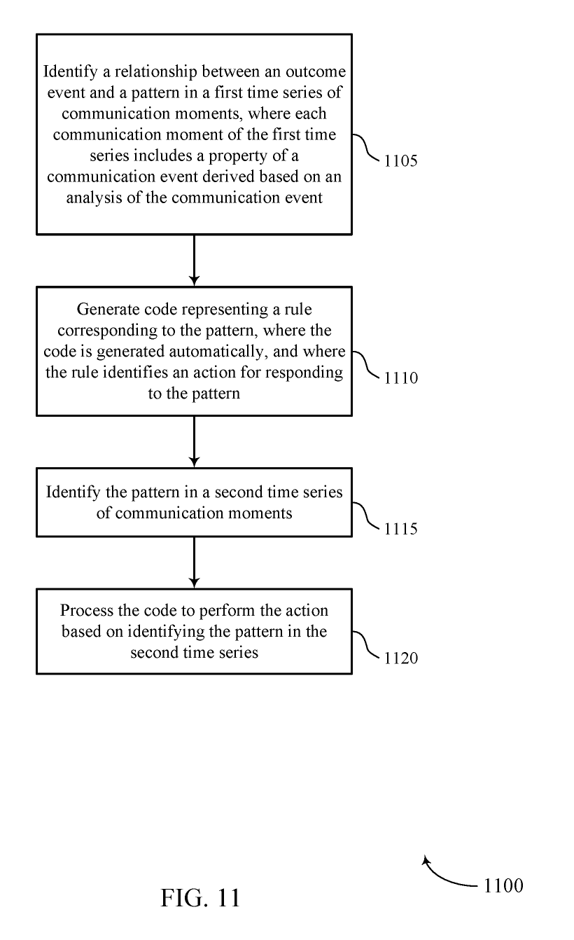

FIG. 11 shows a flowchart illustrating a method 1100 for generating rules based on patterns in a communication time series in accordance with various aspects of the present disclosure. The operations of method 1100 may be implemented by a system 125 or its components as described herein. For example, the operations of method 1100 may be performed by a time series insight manager as described with reference to FIGS. 5 through 7. In some examples, a system 125 may execute a set of codes to control the functional elements of the system to perform the functions described below. Additionally or alternatively, the system 125 may perform aspects of the functions described below using special-purpose hardware.

At block 1105 the system 125 may identify a relationship between an outcome event and a pattern in a first time series of communication moments, wherein each communication moment of the first time series comprises a property of a communication event derived based at least in part on an analysis of the communication event. The operations of block 1105 may be performed according to the methods described with reference to FIGS. 1 through 4. In certain examples, aspects of the operations of block 1105 may be performed by an insight component as described with reference to FIGS. 5 through 7.

At block 1110 the system 125 may generate code representing a rule corresponding to the pattern, wherein the code is generated automatically, and wherein the rule identifies an action for responding to the pattern. The operations of block 1110 may be performed according to the methods described with reference to FIGS. 1 through 4. In certain examples, aspects of the operations of block 1110 may be performed by a rule generating component as described with reference to FIGS. 5 through 7.

At block 1115 the system 125 may identify the pattern in a second time series of communication moments. The operations of block 1115 may be performed according to the methods described with reference to FIGS. 1 through 4. In certain examples, aspects of the operations of block 1115 may be performed by an insight component as described with reference to FIGS. 5 through 7.

At block 1120 the system 125 may process the code to perform the action based at least in part on identifying the pattern in the second time series. The operations of block 1120 may be performed according to the methods described with reference to FIGS. 1 through 4. In certain examples, aspects of the operations of block 1120 may be performed by an action component as described with reference to FIGS. 5 through 7.

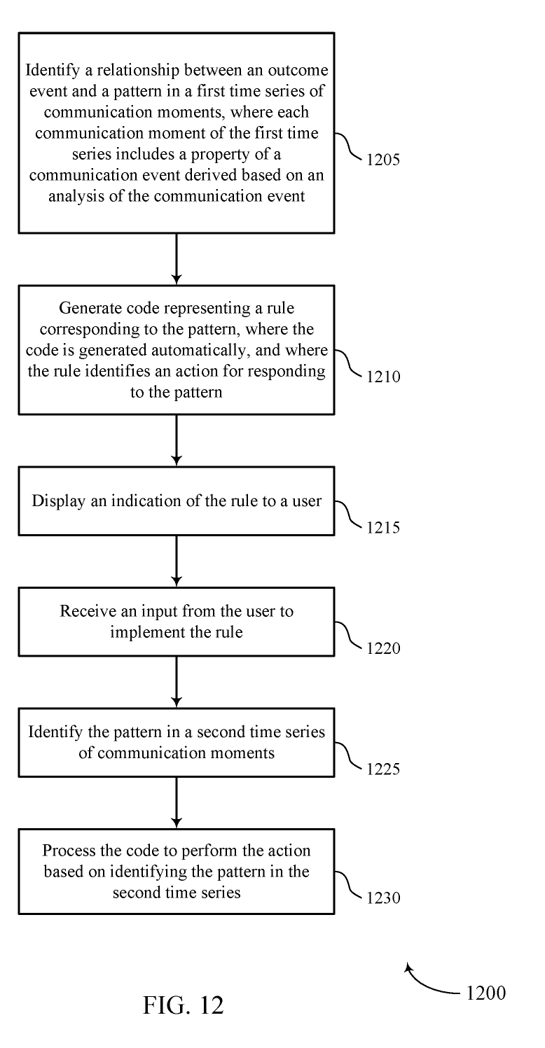

FIG. 12 shows a flowchart illustrating a method 1200 for generating rules based on patterns in a communication time series in accordance with various aspects of the present disclosure. The operations of method 1200 may be implemented by a system 125 or its components as described herein. For example, the operations of method 1200 may be performed by a time series insight manager as described with reference to FIGS. 5 through 7. In some examples, a system 125 may execute a set of codes to control the functional elements of the device to perform the functions described below. Additionally or alternatively, the system 125 may perform aspects of the functions described below using special-purpose hardware.

At block 1205 the system 125 may identify a relationship between an outcome event and a pattern in a first time series of communication moments, wherein each communication moment of the first time series comprises a property of a communication event derived based at least in part on an analysis of the communication event. The operations of block 1205 may be performed according to the methods described with reference to FIGS. 1 through 4. In certain examples, aspects of the operations of block 1205 may be performed by an insight component as described with reference to FIGS. 5 through 7.

At block 1210 the system 125 may generate code representing a rule corresponding to the pattern, wherein the code is generated automatically, and wherein the rule identifies an action for responding to the pattern. The operations of block 1210 may be performed according to the methods described with reference to FIGS. 1 through 4. In certain examples, aspects of the operations of block 1210 may be performed by a rule generating component as described with reference to FIGS. 5 through 7.

At block 1215 the system 125 may display an indication of the rule to a user. The operations of block 1215 may be performed according to the methods described with reference to FIGS. 1 through 4. In certain examples, aspects of the operations of block 1215 may be performed by a presentation component as described with reference to FIGS. 5 through 7.

At block 1220 the system 125 may receive an input from the user to implement the rule. The operations of block 1220 may be performed according to the methods described with reference to FIGS. 1 through 4. In certain examples, aspects of the operations of block 1220 may be performed by an instruction processing component as described with reference to FIGS. 5 through 7.

At block 1225 the system 125 may identify the pattern in a second time series of communication moments. The operations of block 1225 may be performed according to the methods described with reference to FIGS. 1 through 4. In certain examples, aspects of the operations of block 1225 may be performed by an insight component as described with reference to FIGS. 5 through 7.

At block 1230 the system 125 may process the code to perform the action based at least in part on identifying the pattern in the second time series. The operations of block 1230 may be performed according to the methods described with reference to FIGS. 1 through 4. In certain examples, aspects of the operations of block 1230 may be performed by an action component as described with reference to FIGS. 5 through 7.

A method of communication data processing is described. The method may include identifying a relationship between an outcome event and a pattern in a first time series of communication moments, wherein each communication moment of the first time series comprises a property of a communication event derived based at least in part on an analysis of the communication event, generating code representing a rule corresponding to the pattern, wherein the code is generated automatically, and wherein the rule identifies an action for responding to the pattern, identifying the pattern in a second time series of communication moments, and processing the code to perform the action based at least in part on identifying the pattern in the second time series.

Another apparatus for communication data processing is described. The apparatus may include a processor, memory in electronic communication with the processor, and instructions stored in the memory. The instructions may be operable to cause the processor to identify a relationship between an outcome event and a pattern in a first time series of communication moments, wherein each communication moment of the first time series comprises a property of a communication event derived based at least in part on an analysis of the communication event, generate code representing a rule corresponding to the pattern, wherein the code is generated automatically, and wherein the rule identifies an action for responding to the pattern, identify the pattern in a second time series of communication moments, and process the code to perform the action based at least in part on identifying the pattern in the second time series.

A non-transitory computer readable medium for communication data processing is described. The non-transitory computer-readable medium may include instructions operable to cause a processor to identify a relationship between an outcome event and a pattern in a first time series of communication moments, wherein each communication moment of the first time series comprises a property of a communication event derived based at least in part on an analysis of the communication event, generate code representing a rule corresponding to the pattern, wherein the code is generated automatically, and wherein the rule identifies an action for responding to the pattern, identify the pattern in a second time series of communication moments, and process the code to perform the action based at least in part on identifying the pattern in the second time series.

Some examples of the method, apparatus, and non-transitory computer-readable medium described above may further include processes, features, means, or instructions for displaying an indication of the rule to a user. Some examples of the method, apparatus, and non-transitory computer-readable medium described above may further include processes, features, means, or instructions for receiving an input from the user to implement the rule.

Some examples of the method, apparatus, and non-transitory computer-readable medium described above may further include processes, features, means, or instructions for receiving an input from a user to modify the rule, wherein the input comprises an alteration to the code.

Some examples of the method, apparatus, and non-transitory computer-readable medium described above may further include processes, features, means, or instructions for displaying an indication of the pattern to a user.

Some examples of the method, apparatus, and non-transitory computer-readable medium described above may further include processes, features, means, or instructions for displaying a forecasted relationship between the outcome event and the rule.

Some examples of the method, apparatus, and non-transitory computer-readable medium described above may further include processes, features, means, or instructions for identifying the pattern in the first time series, wherein identifying the pattern in the first time series comprises identifying a time duration between communication moments of different types, identifying a sequence of occurrences between communication moments of different types, identifying a ratio between communication moments of different types, or identifying a combination thereof.

Some examples of the method, apparatus, and non-transitory computer-readable medium described above may further include processes, features, means, or instructions for receiving an input from a user to select the types of communication moments to use for identifying the pattern.

Some examples of the method, apparatus, and non-transitory computer-readable medium described above may further include processes, features, means, or instructions for receiving at least a new communication event. Some examples of the method, apparatus, and non-transitory computer-readable medium described above may further include processes, features, means, or instructions for updating the first time series based at least in part on the new communication event.

Some examples of the method, apparatus, and non-transitory computer-readable medium described above may further include processes, features, means, or instructions for updating the code based at least in part on the updated first time series.

In some examples of the method, apparatus, and non-transitory computer-readable medium described above, the property of the communication event comprises an occurrence associated with the communication event, a score associated with the communication event, or a combination thereof.

In some examples of the method, apparatus, and non-transitory computer-readable medium described above, the communication event comprises an email, a calendar event, a service ticket, a SMS text message, a voice call, a social media message, or a combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for communication data processing, comprising:
identifying a relationship between an outcome event and a pattern in a first time series of communication moments, wherein each communication moment of the first time series comprises a property of a communication event derived based at least in part on an analysis of the communication event;
generating code representing a rule corresponding to the pattern, wherein the code is generated automatically, and wherein the rule identifies an action for responding to the pattern;
identifying the pattern in a second time series of communication moments; and
processing the code to perform the action based at least in part on identifying the pattern in the second time series.

2. The method of claim 1, further comprising:
displaying an indication of the rule to a user; and
receiving an input from the user to implement the rule.

3. The method of claim 1, further comprising:
receiving an input from a user to modify the rule, wherein the input comprises an alteration to the code.

4. The method of claim 1, further comprising:
displaying an indication of the pattern to a user.

5. The method of claim 1, further comprising:
displaying a forecasted relationship between the outcome event and the rule.

6. The method of claim 1, further comprising:
identifying the pattern in the first time series, wherein identifying the pattern in the first time series comprises identifying a time duration between communication moments of different types, identifying a sequence of occurrences between communication moments of different types, identifying a ratio between communication moments of different types, or identifying a combination thereof.

7. The method of claim 6, further comprising:
receiving an input from a user to select the types of communication moments to use for identifying the pattern.

8. The method of claim 1, further comprising:
receiving at least a new communication event; and
updating the first time series based at least in part on the new communication event.

9. The method of claim 8, further comprising:
updating the code based at least in part on the updated first time series.

10. The method of claim 1, wherein the property of the communication event comprises an occurrence associated with the communication event, a score associated with the communication event, or a combination thereof.

11. The method of claim 1, wherein the communication event comprises an email, a calendar event, a service ticket, a short message service (SMS) text message, a voice call, a social media message, or a combination thereof.

12. An apparatus for communication data processing, in a system comprising:
a processor;
memory in electronic communication with the processor; and
instructions stored in the memory and operable, when executed by the processor, to cause the apparatus to:
identify a relationship between an outcome event and a pattern in a first time series of communication moments, wherein each communication moment of the first time series comprises a property of a communication event derived based at least in part on an analysis of the communication event;
generate code representing a rule corresponding to the pattern, wherein the code is generated automatically, and wherein the rule identifies an action for responding to the pattern;
identify the pattern in a second time series of communication moments; and
process the code to perform the action based at least in part on identifying the pattern in the second time series.

13. The apparatus of claim 12, wherein the instructions are further executable by the processor to:
display an indication of the rule to a user; and
receive an input from the user to implement the rule.

14. The apparatus of claim 12, wherein the instructions are further executable by the processor to:
receive an input from a user to modify the rule, wherein the input comprises an alteration to the code.

15. The apparatus of claim 12, wherein the instructions are further executable by the processor to:
identify the pattern in the first time series, wherein identifying the pattern in the first time series comprises identifying a time duration between communication moments of different types, identifying a sequence of occurrences between communication moments of different types, identifying a ratio between communication moments of different types, or identifying a combination thereof.

16. The apparatus of claim 12, wherein the instructions are further executable by the processor to:
receive at least a new communication event; and
update the first time series based at least in part on the new communication event.

17. A non-transitory computer readable medium storing first code for communication data processing, the first code comprising instructions executable by a processor to:
identify a relationship between an outcome event and a pattern in a first time series of communication moments, wherein each communication moment of the first time series comprises a property of a communication event derived based at least in part on an analysis of the communication event;
generate second code representing a rule corresponding to the pattern, wherein the second code is generated automatically, and wherein the rule identifies an action for responding to the pattern;
identify the pattern in a second time series of communication moments; and
process the second code to perform the action based at least in part on identifying the pattern in the second time series.

18. The non-transitory computer-readable medium of claim 17, wherein the instructions are further executable by the processor to:
display an indication of the rule to a user; and
receive an input from the user to implement the rule.

19. The non-transitory computer-readable medium of claim 17, wherein the instructions are further executable by the processor to:
receive an input from a user to modify the rule, wherein the input comprises an alteration to the second code.

20. The non-transitory computer-readable medium of claim 17, wherein the instructions are further executable by the processor to:
identify the pattern in the first time series, wherein identifying the pattern in the first time series comprises identifying a time duration between communication moments of different types, identifying a sequence of occurrences between communication moments of different types, identifying a ratio between communication moments of different types, or identifying a combination thereof.
